(19) United States
(12) Patent Application Publication
(10) Pub. No.: US 2008/0112019 A1
(43) Pub. Date: May 15, 2008

(54) IMAGE PROCESSING APPARATUS AND IMAGE PROCESSING METHOD

(75) Inventor: Toshikazu KAWAGUCHI, Kobe-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/829,168

(22) Filed: Jul. 27, 2007

(30) Foreign Application Priority Data
Nov. 15, 2006 (JP) 2006-309662

(51) Int. Cl. H04N 1/04

(52) U.S. Cl. 358/474; 358/403; 358/450; 358/498; 382/312

(57) ABSTRACT

An image processing apparatus comprising: a first reader that reads a first side of a document; a second reader that reads a second side of the document; a reducer that reduces in the sub-scanning direction image data read out by said first reader from the first side of the document and image data read out by said second reader from the second side of the document; a storage that stores therein the respective image data reduced by said reducer, which originate from the first and second sides of the document; a judger that judges based on the respective image data stored in said storage, which originate from the first and second sides of the document, whether or not the document is a particular document; and a controller that prohibits said respective image data originating from the first and second sides of the document, from being outputted, depending on a judgment result drew by said judger.

This application claims priority under 35 U.S.C. § 119 to Japanese Patent Application No. 2006-309662 filed on Nov. 15, 2006, the entire disclosure of which is incorporated herein by reference in its entirety.

### BACKGROUND OF THE INVENTION

1. Field of the Invention

The present invention relates to an image processing apparatus reading frontside and backside of a document simultaneously and detecting a particular document such as a banknote, which is applied to a copier, etc., and an image processing method.

2. Description of the Related Art

The following description sets forth the inventor's knowledge of related art and problems therein and should not be construed as an admission of knowledge in the prior art.

There exist image processing apparatuses reading frontside and backside of a document simultaneously, and some of them judge whether or not the document is a particular document such as a banknote, a paper of value, etc. For example, if a particular document is copied, then this kind of image processing apparatus detects the particular document and prohibits the document from being copied.

On the other hand, the image processing apparatuses mentioned above, which read frontside and backside of a document simultaneously, process respective image data read out from frontside and backside of the document also simultaneously, but individually. That is why this kind of image processing apparatus comprises two processors in many cases: one is to process the image data read out from frontside of the document and the other one is to process the image data read out from backside of the document. Further, this kind of image processing apparatus comprises other two processors in many cases: one is to judge based on the image data read out from frontside of the document whether or not the document is a particular document and the other one is to judge in the same manner based on the image data read out from backside of the document.

That means this kind of image processing apparatus necessarily comprises more processors, which makes its internal configuration too complicated.

According to Japanese Laid-open Patent Publication No. 2005-26880, respective image data read out from frontside and backside of a document are reduced in the main scanning direction, then the respective reduced image data are connected to each other. And then a document judger judges based on the connected image data whether or not the document is a particular document, in other words, only one document judger judges based on the respective image data originating from frontside and backside of the document whether or not the document is a particular document.

However, the art disclosed in the publication right above leaves a problem in judgment accuracy: respective image data read out from frontside and backside of the document are reduced in the main scanning direction and connected to each other, thus sometimes the respective image data are partly confused in the connecting area, which could cause the document judger makes wrong judgment.

It leaves another problem in its configuration: with the configuration to read frontside and backside of the document simultaneously, the timings to start reading in the main scanning direction frontside and backside of the document are adjusted almost to the same. Thus, another function is additionally needed to differentiate the timings to reduce in the main scanning direction and connect the respective image data read out from frontside and backside of the document, which makes the configuration more complicated.

It leaves yet another problem in its operations: data of lines are read in the main scanning direction and the operation is repeated in the sub-scanning direction until the whole image is completely read. Thus, in order to reduce in the main scanning direction the image data read out from frontside and backside of the document, data of the respective lines read by a sensor in the main scanning direction need to be thinned out of spots, which makes the operations too complicated.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image processing apparatus that reads both respective sides of a document simultaneously, judges highly accurately with a simple configuration whether or not the document is a particular document, and does not have to thin out of spots data of respective lines extended in the main scanning direction.

It is another object of the present invention to provide an image processing method that reads both respective sides of a document simultaneously, judges highly accurately with a simple configuration whether or not the document is a particular document, and does not have to thin out of spots data of respective lines extended in the main scanning direction.

According to a first aspect of the present invention, an image processing apparatus comprises:
a first reader that reads a first side of a document;
a second reader that reads a second side of the document;
a reducer that reduces in the sub-scanning direction image data read out by said first reader from the first side of the document and image data read out by said second reader from the second side of the document;
a storage that stores therein the respective image data reduced by said reducer, which originate from the first and second sides of the document;
a judger that judges based on the respective image data stored in said storage, which originate from the first and second sides of the document, whether or not the document is a particular document; and
a controller that prohibits said respective image data originating from the first and second sides of the document, from being outputted, depending on a judgment result drew by said judger.

According to a second aspect of the present invention, an image processing method comprises:
a first reading step to read a first side of a document;
a second reading step to read a second side of the document;
a reducing step to reduce in the sub-scanning direction image data read out from the first side of the document in said first reading step and image data read out from the second side of the document in said second reading step;
a storing step to store in a storage the respective image data reduced in said reducing step, which originate from the first and second sides of the document;
a judging step to judge based on the respective image data stored in said storage, which originate from the first and second sides of the document, whether or not the document is a particular document; and
a prohibiting step to prohibit the respective image data originating from the first and second sides of the document, from being outputted, depending on a judgment result drew in said judging step.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing a configuration of a reading mechanical part that is used in an image processing apparatus according to one embodiment of the present invention;

FIG. 2 is a view showing a configuration of a second reader;

FIG. 3 is a block diagram showing a functional configuration of the image processing apparatus;

FIG. 4 is a block diagram showing a functional configuration of an image processor;

FIG. 5 is a view to explain a method to generate image data for judgment whether or not the document is a particular document;

FIG. 6 is a view to explain a method to generate image data for judgment whether or not the document is a particular document, if the timings to start reading frontside and backside of the document are different;

FIG. 7 is a flowchart to explain operations performed by the image processing apparatus;

FIG. 8 is a flowchart continued from FIG. 7.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

In this embodiment, an image forming apparatus such as a MFP (Multi Function Peripheral) that is a digital multifunction complex machine is used as an image processing apparatus.

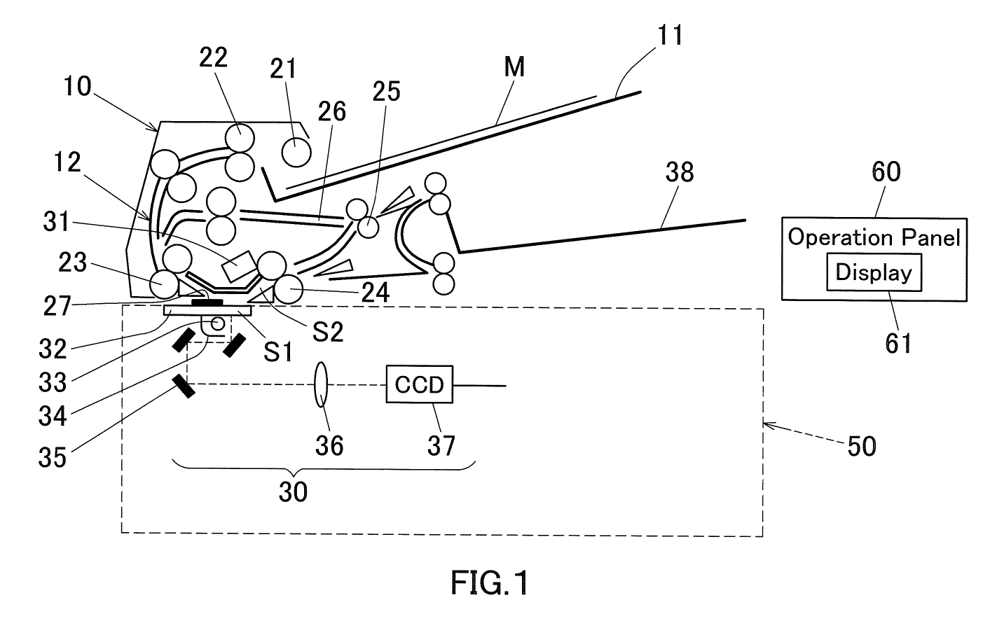

As shown in FIG. 1, a reading mechanical part comprises a sheet-through type ADF (automatic document feeder) 10 that transfers a document and reads an image on the document simultaneously, a scanner 50, and an operation panel 60.

The ADF 10 comprises a paper tray 11 and a document feeder 12.

The paper tray 11 loads a document M therein to prepare for paper feed.

The document feeder 12 comprises a feed roller 21 that pulls out the document M loaded in the paper tray 11, a separation roller 22 that separates the document M from the paper tray 11, a pre-reading roller 23 that is provided at the top of a first image readable area S1, and a post-reading roller 24 that is provided at the bottom of the first image readable area S1. In addition, it comprises a reverse path 26 that temporarily discharges the document M after reading one side of the document M, and reverses the discharged document M by a switchback roller 25, and then guides the reversed document M toward the first image readable area S1.

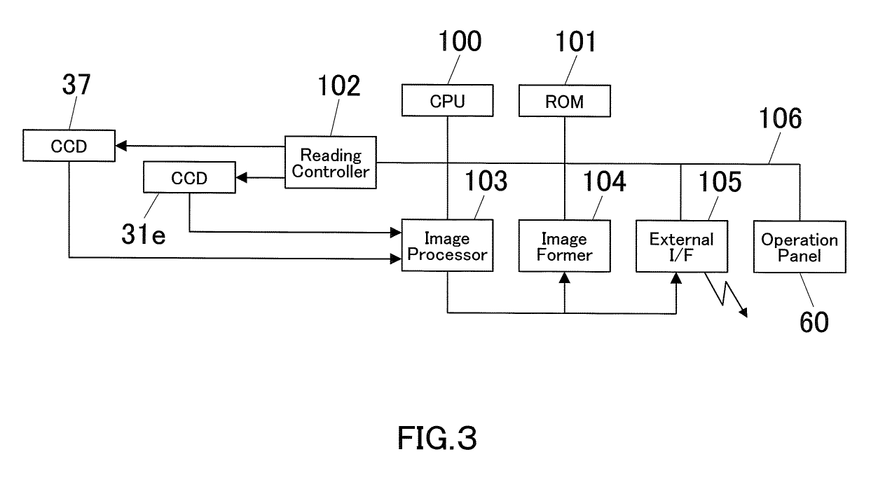

The ADF 10 performs paper feed, paper transfer and other operations under the control of a reading controller 102 (shown in FIG. 3).

A first reader 30 that reads paper slipping through the first image readable area S1 and a second reader 31 that reads paper slipping through a second image readable area S2 are provided in predetermined places across the transfer path, and the second image readable area S2 is located slightly downstream of the transfer path than the first image readable area S1.

The scanner 50 comprises the first reader 30, and reads both a full-color document and a monochrome document.

The first reader 30 comprises an exposure circuit 33 that exposes via a platen glass 32 the document M incoming to the first image readable area S1, a light reflecting plate 34, a plurality of mirrors 35 that guides the light reflected from the document M toward a CCD 37, and a lens 36 that is provided between the mirrors 35 and the CCD 37 that is a line sensor. Specifically, a transfer guide 27 is provided on the platen glass 32 in the first image readable area S1, and it makes the document M incoming to the first image readable area S1, transferred contactlessly with the platen glass 32.

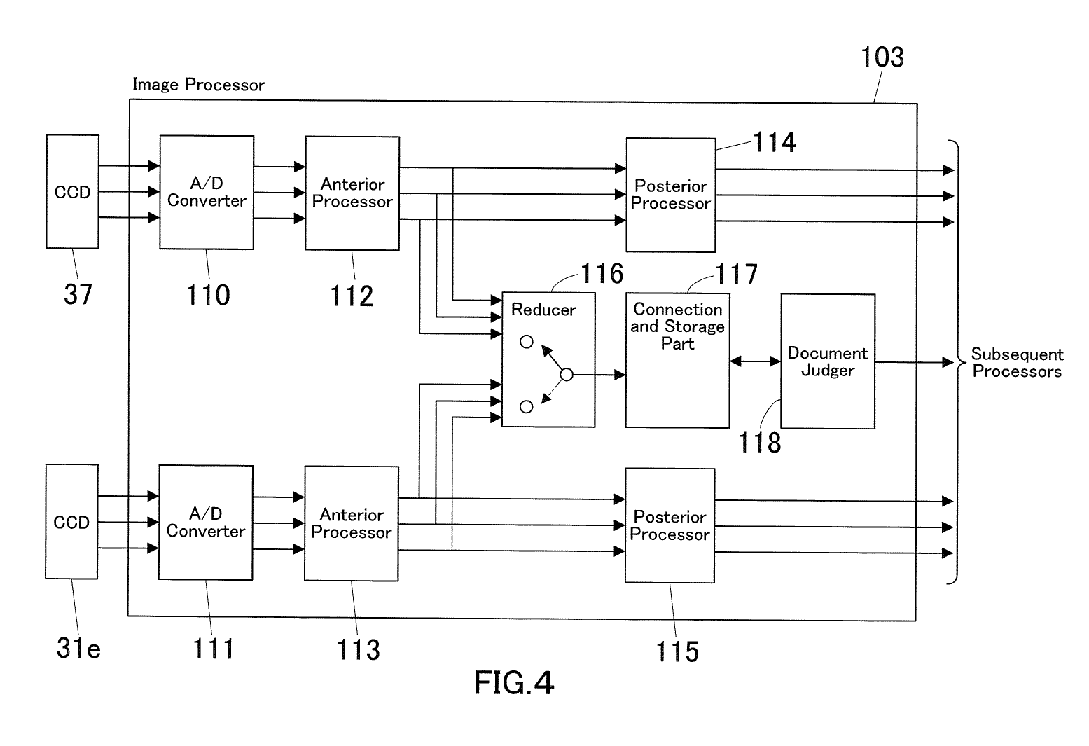

Analog signals inputted to an image processor 103 from the CCD 37 are converted to digital ones by an A/D converter 110 (shown in FIG. 4), then processed in a predetermined manner.

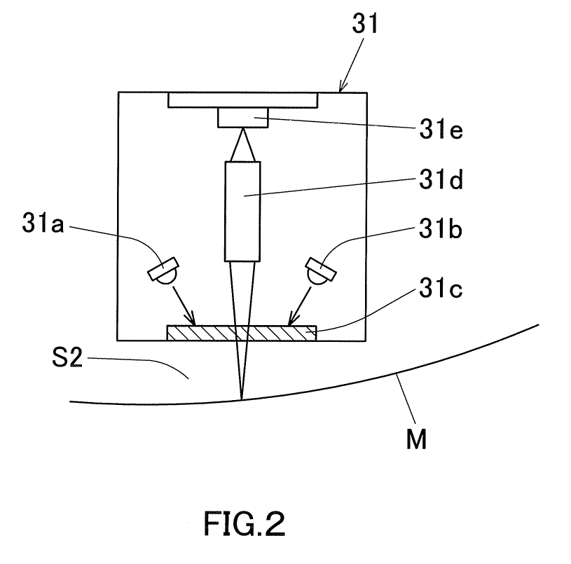

The second reader 31 provided on the side of the ADF 10 is a CIS (Contact Image Sensor) that reads both a full-color document and a monochrome document, which functions are the same as the first reader 30. As shown in FIG. 2, the second reader 31 comprises a pair of LEDs, a LED 31a and a LED 31b, that irradiate light via a glass 31c on the document M incoming to the second image readable area S2, and a SELFOC lens 31d that collects the light reflected from the document M, and a line sensor 31e that receives the collected light. In this embodiment, a CCD is adopted as the line sensor 31e, however, another light receiving element such as a CMOS sensor can be also adopted.

Analog signals inputted to the image processor 103 from the line sensor 31e that is a CCD are converted to digital ones by an A/D converter 111 (shown in FIG. 4), then processed in a predetermined manner.

In this image processing apparatus, the feed roller 21 feeds the document M loaded in the paper tray 11, then the separation roller 22 and the pre-reading roller 23 transfer the document M to the first image readable area S1.

In the scanner 50, the exposure circuit 33 of the first reader 30 exposes an image on one side (frontside) of the document M slipping through the first image readable area S1, then the platen glass 32 and the lens 36 instruct the light reflected from the image on one side of the document M, to the CCD 37. Subsequently, the image processor 103 generates image data based on RGB data from the CCD 37.

When the document M slips through the second image readable area S2 after the first image readable area S1, the second reader 31 reads an image on the other side (backside) of the document M to generate image data.

After the document M slips through the second image readable area S2, the post-reading roller 24 transfers the document M to a discharge tray 38 rightward in FIG. 1.

As described above in this embodiment, the document M loaded in the paper tray 11 is routed via the first image readable area S1 and the second readable area S2 to the discharge tray 38, without being switched back to the image readable area. Once the document M is fed, not only one side of the document M is read by the first reader 30 but also the other side of the document M is read by the second reader 31. Briefly, only one feed enables reading double sides of the document M.

### [Overall Configuration]

Hereinafter, a configuration of the image processing apparatus will be explained with reference to a functional block diagram shown in FIG. 3.

As shown in FIG. 3, the image processing apparatus comprises a CPU 100, a ROM 101, a reading controller 102, the image processor 103, an image former 104, an external interface (I/F) 105, the CCD 37, the CCD (line sensor) 31e, an operation panel 60, etc. The ROM 101, the reading controller 102, the image processor 103, the image former 104, the external interface 105 and the operation panel 60 are connected to a bus line 60 extended from the CPU 100.

The CPU 100 controls the overall image processing apparatus. Detailed explanation will be provided later.

The ROM 101 records an operation program for the CPU 100 and other data therein.

The reading controller 102 comprises a CPU for the scanner (not shown in Figure) and controls an overall reading mechanical part shown in FIG. 1 and FIG. 2. For example, the reading controller 102 judges the level of image quality or resolution, which is to be required for document reading, makes the document feeder 12 feed the document M, and makes the first reader 30 and the second reader 31 read the document M.

The image processor 103 processes image data inputted from the CCD 37 and the CCD 31e, in a predetermined manner. Detailed explanation will be provided later.

The image former 104 forms an image based on the image data inputted from the image processor 103, then outputs the image on a sheet.

The external interface 105 functions as a communicator that exchanges data with an external terminal, etc., via a network circuit, etc.

The operation panel 60 is used by user to give various instructions, enter an operation mode, and display status of the apparatus, a message, etc., and comprises a touch panel display 61 as shown in FIG. 1. By using the operation panel 60, an administrator, etc. configures a level of picture quality or resolution, which is to be required for document reading, then the CPU 100 receives the configured level.

### [Configuration of the Image Processor]

Hereinafter, a configuration of the image processor 103 will be explained with reference to FIG. 4.

As shown in FIG. 4, the image processor 103 comprises the A/D converters 110 and 111, anterior processors 112 and 113, posterior processors 114 and 115, a reducer 116, a connection and storage part 117, a document judger 118, etc. The A/D converter 110, the anterior processor 112 and the posterior processor 114 process image data read out from one side of the document M by the CCD 37 of the first reader 30, meanwhile the A/D converter 111, the anterior processor 113 and the posterior processor 115 process image data read out from the other side of the document M by the CCD 31e of the second reader 31.

Concretely, the A/D converter 110 converts to digital signals the image data read out from one side (frontside) of the document M by the CCD 37, meanwhile the A/D converter 111 converts to digital signals the image data read out from the other side (backside) of the document M by the CCD 31e.

The anterior processors 112 and 113 perform shading correction, line correction, etc., on the digital signals that is the image data inputted from the A/D converters 110 and 111, respectively.

The posterior processors 114 and 115 perform image quality improvement and color conversion on the image data, then outputs the processed image data to the image former 104 and the external interface 105.

The reducer 116 picks up data of every other line in the sub-scanning direction, alternately from the image data read out from frontside and backside of the document. Then, the reducer 116 outputs the picked data to the connection and storage part 117. Concretely, in this embodiment, data of odd number of lines are picked up from the image data read out from frontside of the document, and data of even number of lines are picked up from the image data read out from backside of the document, and then the picked data are outputted to the connection and storage part 117. In other words, the respective image data read out from frontside and backside of the document are thinned out of every other line, and then the respective 50% thinned image data is outputted to the connection and storage part 117.

The connection and storage part 117 is a memory, and generates image data for judgment whether or not the document is a particular document, by connecting and storing in alternating layers the respective image data thinned out of every other line by the reducer 116, which originate from frontside and backside of the document. The connection and storage part 117 also can store the anterior data of the frontside and the posterior data of the backside, which are simply connected to each other, not in alternating layers.

The document judger 118 judges whether or not the image data for document judgment, which is stored on the connection and storage part 117, corresponds to image data of a particular document, in other words, whether or not the read document is a particular document. This judgment is done by pattern matching between the image data for document judgment and preliminarily recorded dictionary data (image data of a particular document), and by comparing pixel values in corresponding areas of the respective image data above. A method for document judgment is not limited to the one mentioned right above, and arbitrarily employed.

The document judger 118 acquires partly or wholly data of odd number of lines from the image data stored on the connection and storage part 117 before judgment whether or not foreside of the document is of a particular document, and then performs the document judgment based on the acquired data. Meanwhile, the document judger 118 acquired partly or wholly data of even number of lines from the image data stored on the connection and storage part 117 before judgment whether or not backside of the document is of a particular document, and then performs the document judgment based on the acquired data.

Depending on the judgment result drew by the document judger 118, the CPU 100 controls operations in a predetermined manner as described hereinbelow.

### [Detailed Explanation of a Method to Generate Image Data for Document Judgment]

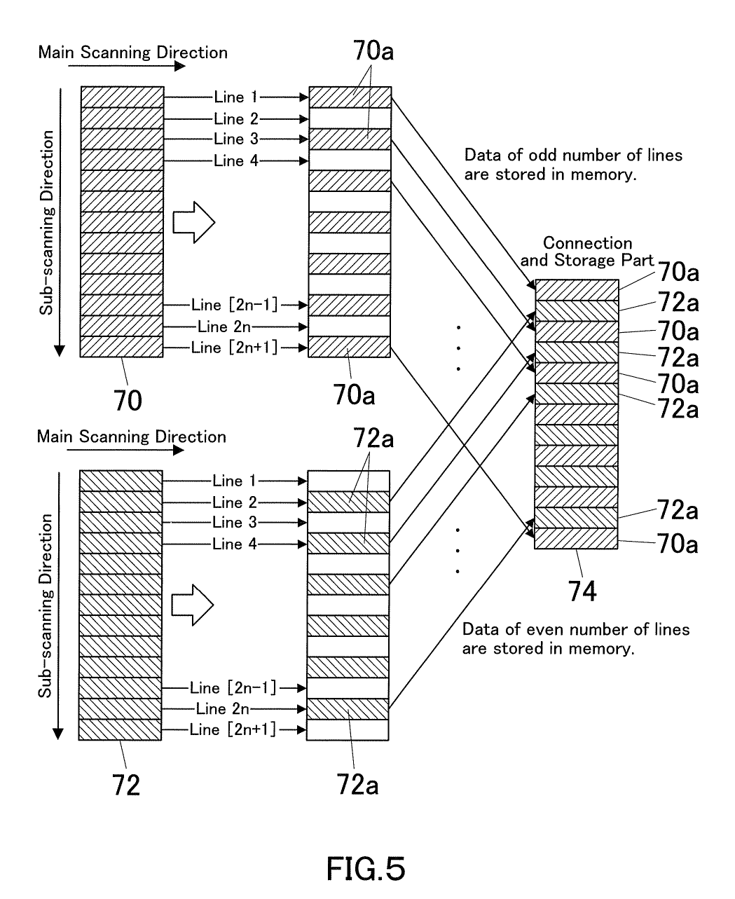

The method to generate image data for document judgment in the image processor 103, which is previously mentioned, will be further explained with reference to FIG. 5. In FIG. 5, data of one line extended in the main scanning direction corresponds to the data acquired by one operation of those repeated by the line sensor (CCD) when a document is read.

First, the reducer 116 acquires image data 70a of the odd number (1, 3, . . . [2n+1]) of lines in the sub-scanning direction, from image data 70 inputted from the anterior processor 112, which is read out from frontside of the document, and image data 72a of the even number (2, 4, . . . [2n]) of lines in the sub-scanning direction, from image data 72 inputted from the anterior processor 113, which is read out from backside of the document. Then, the acquired image data are outputted to the connection and storage part 117.

The connection and storage part 117 connects and stores the image data 70a of odd number of lines and the image data 72a of even number of lines sequentially inputted from the reducer 116, and continues the operation until the whole sheet of document is completely read. In this way, the image data of odd number of lines, which are acquired from the image data 70 read out from frontside of the document, and the image data of even number of lines, which are acquired from the image data 72 read out from backside of the document, are connected and stored in alternating layers to form image data 74 for document judgment. The image data 74 for document judgment corresponds to the image data 70 read out from frontside of the document and the image data 72 read out from backside of the document, which are thinned out of every other line, in other words, 50% thinned out, respectively.

In this embodiment, data of odd number of lines are acquired from the image data 70 read out from frontside of the document, meanwhile data of even number of lines are acquired from the image data 72 read out from backside of the document, and then the respective acquired data are stored on the connection and storage part 117. However, a method to acquire data is not limited to the method right above. Alternatively, for example, data of the number 1, 4, . . . [3n+1] (n: counting number) of lines are acquired from the image data 70 read out from frontside of the document, meanwhile data of the number 2, 5, . . . [3n+2] (n: counting number) of lines are acquired from the image data 72 read out from backside of the document, and these operations are alternately performed. To generalize, data of the number [Nn+k] (N, n, k: counting number, 0≦k≦n−1) of lines are acquired from the image data 70 read out from frontside of the document, meanwhile data of the number [Nn+l] (N, n, l: counting number, 0≦1≦n−1, k≠l) of lines are acquired from the image data 72 read out from backside of the document, and these operations are alternately performed.

Alternatively, data of anterior lines (from the line 1 through the line n) are acquired from the image data 70 read out from frontside of the document, then stored on the connection and storage part 117, meanwhile data of posterior lines (from the line [n+1] through the line [2n+1]) are acquired from the image data 72 read out from backside of the document, then stored on the connection and storage part 117. Alternatively, data of every plurality of lines are acquired alternately from the image data 70 read out from frontside of the document and the image data 72 read out from backside of the document. For example, data of every two lines are acquired from the image data 70 read out from frontside of the document, meanwhile data of every three lines are acquired from the image 72 read out from backside of the document, and these operations are alternately performed.

As described above in this embodiment, respective image data read out from frontside and backside of a document are reduced in the sub-scanning direction then stored on the connection and storage part 117, and then it is judged by the document judger 118 based on the respective stored image data whether or not the document is a particular document. Therefore, the respective image data read out from frontside and backside of a document are not even separated without confusion in the connecting area, and document judgment is performed highly accurately. On the other hand, the conventional image processing apparatus reduces in the main scanning direction and connects the respective image data read out from frontside and backside of a document, and then judges based on the image data whether or not the document is a particular document, which could lose judgment accuracy due to confusion in the connecting area.

Further, the image data is reduced in the sub-scanning direction by simply being thinned out of lines. Thus, any of an exclusive circuit for data reducing, a line buffer to layout appropriately in the main scanning direction respective image data read out from frontside and backside of a document, and a process to thin out of spots data of respective lines extended in the main scanning direction are not necessary, which makes the configuration and processing simple. Further, document judgment is performed at a speed that is the same as the clock speed at which image processing is performed.

### [Document Judgment if Timings to Start Reading Frontside and Backside of Document are Different]

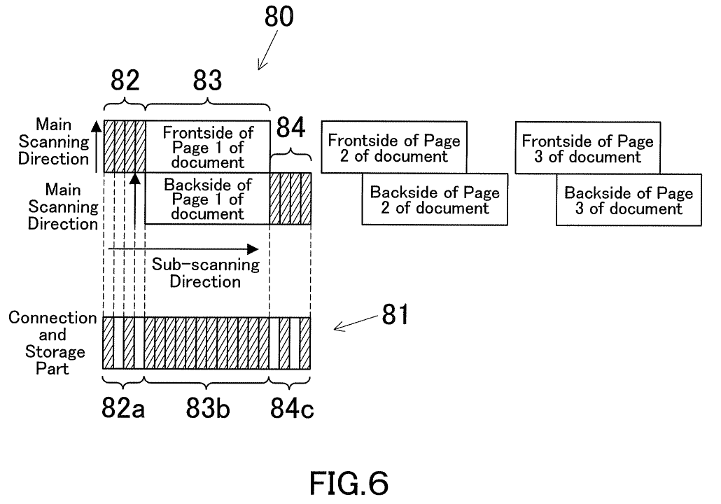

The CCD 37 that reads frontside of the document and the CCD 31e that reads backside of the document are provided in different positions. That causes differences between the timings of start reading frontside and backside of the document, and between the timings of outputting to the reducer 116 the image data 70 read out from frontside of the document and the image data 72 read out from backside of the document. Therefore, the two image data are inputted to the reducer 116 at different timings, as shown in FIG. 6.

Data of lines acquired only from the image data 70 read out from frontside of the document are inputted to an area 82, data of lines respectively acquired from the image data 70 and 72 read out from frontside and backside of the document are inputted to an area 83, data of lines acquired only from the image data 72 read out from backside of the document are inputted to an area 84, and the respective acquired data are stored on the connection and storage part 117. In this way, image data 81 for document judgment, which is shown in FIG. 6, is generated. The image data 81 for document judgment includes an anterior area 82a having data of every other line acquired only from the image data 70 read out from frontside of the document, a middle area 83a having in alternating layers data of every other line acquired respectively from the image data 70 and 72 read out from frontside and backside of document, and an posterior area 84c having data of every other line acquired only from the image data 72 read out from backside of the document.

The document judger 118 judges based on the anterior area 82a of the image data 81 for document judgment whether or not only frontside of the document is of a particular document, judges based on the middle area 83b of the image data 81 whether or not both frontside and backside of the document is of a particular document, from the posterior area 84c of the image data 81 whether or not only backside of the document is of a particular document.

As described above, document judgment is successfully performed without minding if the timings to start reading frontside and backside of a document are different, or a need of a line buffer adjusting the timings, which makes a configuration of the apparatus simple. Further, it is judged based on the area 82a having data only from the image data read out from frontside of the document and the area 84c having data only from the image data read out from backside of the document, whether or not just one side of the document is of a particular document, respectively. That makes the processing time of document judgment shortened.

### [Operations of the Image Processing Apparatus]

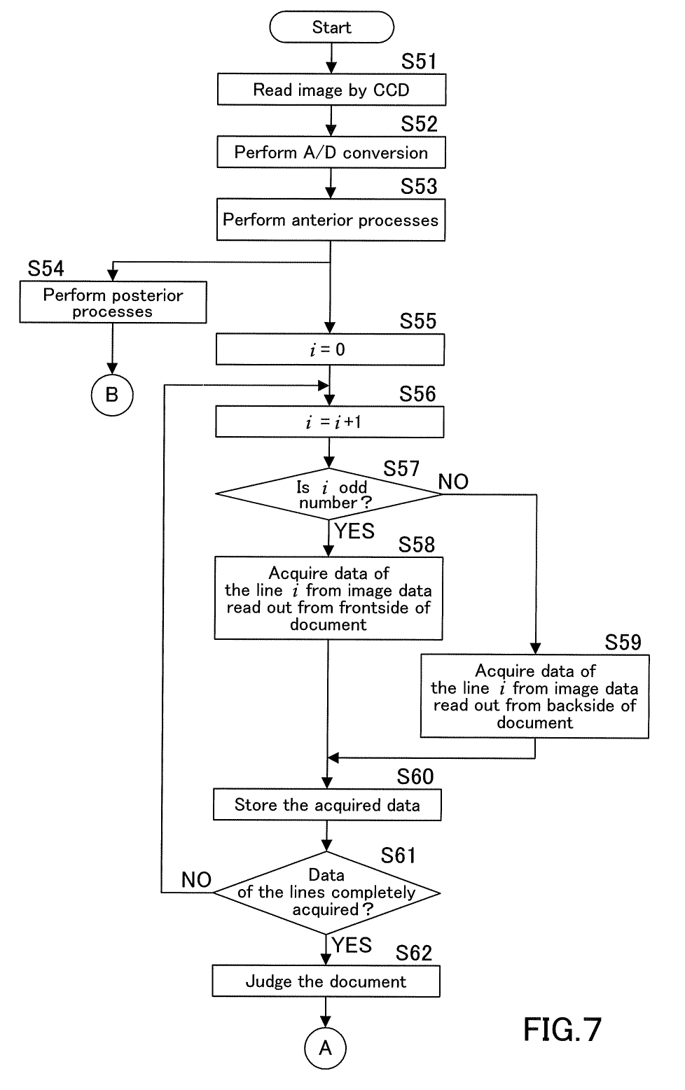

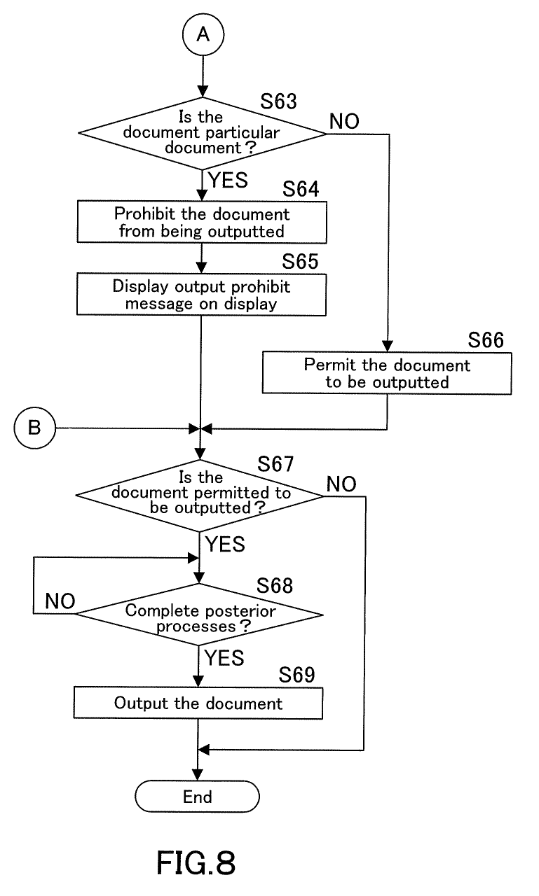

Hereinafter, a series of procedures performed in the image processing apparatus shown in FIG. 1 through FIG. 4, will be orderly explained with reference to the flowchart in FIG. 7 and FIG. 8.

An image on frontside of the document M is read by the CCD 37 and an image on backside of the document M is read by the CCD 31e (Step S51). Then image data read out from frontside of the document is converted to digital signals by the A/D converter 110 and image data read out from backside of the document is converted to digital signals by the A/D converter 111 (Step S52).

Anterior processes such as shading correction, line correction, etc. are performed by the anterior processor 112 on the digitalized image data that is read out from frontside of the document, and anterior processes such as shading correction, line correction, etc. are performed by the anterior processor 113 on the digitalized image data that is read out from backside of the document (Step S53). The processed image data is outputted to the reducer 116, and the posterior processors 114 or 115.

Posterior processes such as image quality improvement, color conversion, etc. are processed by the posterior processors 114 and 115 on the respective inputted image data that are read out frontside and backside of the document (Step S54). Then the routine proceeds directly to Step S67.

Simultaneously with the posterior processes mentioned above, image data for judgment whether or not the document is a particular document is generated and the document judgment is performed. Concretely, a variable i is set to “0” (Step S55) and “1” is added to the valuable i (Step S56), and then it is judged whether or not the valuable i is an odd number (Step S57), by the reducer 116.

If it is judged the valuable i is an odd number (YES in Step S57), data of the line number i in the sub-scanning direction is acquired from the image data 70 read out from frontside of the document (Step S58), then stored in the connection and storage part 117 (Step S60). On the other hand, if it is judged the valuable i is an even number (NO in Step S57), data of the line number i in the sub-scanning direction is acquired from the image data 72 read out from backside of the document (Step S59), then stored in the connection and storage part 117 (Step S60).

Subsequently in Step S61, it is judged by the reducer 116 whether or not data of the lines are completely acquired from the image data 70 read out from frontside of the document and data of the lines are completely acquired from the image data 72 read out from backside of the document. If it is judged data of the lines are not yet completely acquired (NO in Step S61), the routine returns to Step S56 to repeat Steps S56 through S61. If it is judged data of the line is completely acquired (YES in Step S61), the routine proceeds to Step S62.

In this way, the image data 74 for document judgment shown in FIG. 5 is generated by the connection and storage part 117.

In Step S62, it is judged by the document judger 118 whether or not the respective image data originating from frontside and backside of the document M correspond to the image pattern of a particular document, which are stored in the apparatus. Then, in Step S63 shown in FIG. 8, it is judged by the document judger 118 whether or not either of the image data originating from frontside and backside of the document M corresponds to the image pattern of a particular document, in other words, the document M is a particular one.

If it is judged the document is a particular one (YES in Step S63), the document is prohibited to be outputted in Step S64, and a message is displayed on the display 61 to notify output prohibit in Step S65, and then the routine proceeds to Step S67. If it is judged neither of the image data read out from frontside and backside of the document M corresponds to the image pattern of a particular document (NO in Step S63), then the document is permitted to be outputted in Step S66, and then the routine proceeds to Step S67.

In Step S67, it is judged by the CPU 100 whether or not the document is permitted to be outputted. If it is judged the document is permitted (YES in Step S67), then it is judged in Step S68 by the CPU 100 whether or not posterior processes are completed. If those are not yet completed (NO in Step S68), the routine waits until it is completed. If those are completed (YES in Step S68), the image data read out from the document is outputted via the image former 104 or is outputted via the external interface 105 to an external device (Step S69), by the CPU 100. Then, the routine terminates.

If it is judged the document is not permitted to be outputted (NO in Step S67), then the routine directly terminates.

In this embodiment described above, the document is prohibited from being outputted if it is judged either of the image data originating from frontside and backside of the document M corresponds to the image pattern of a particular document. Alternatively, the image data originating from the document M is converted to data of a particular pattern, which is not suitable for practical use (e.g. blackout data), then outputted (printed) and a message notifying of copy prohibit is displayed on the display 61.

Further, if the image data is to be outputted (transmitted) to an external terminal, it is prohibited from being outputted, or alternatively, it is converted by image processing into data of a particular pattern, which is not suitable for practical use, then outputted (transmitted) and a message notifying of output prohibit is displayed on the display of the external device.

In this embodiment, data of lines in the sub-scanning direction are acquired alternately from respective image data read out from frontside and backside of a document, then stored in a connection and storage part. Thus, data reducing of the respective image data read out from frontside and backside of the document is performed without an exclusive circuit for data reducing. In other words, image processing are sequentially performed with one reducer and one connection and storage part, and then one document judger judges whether or not the document is a particular document. Further, the document judger never makes a wrong judgment due to data in a connecting area of the image data read out from frontside and backside of the document.

Further, since the respective image data read out from frontside and backside of the document are thinned out of every other line and stored in alternating layers in a memory of the apparatus, the original whole image is hardly conjectured from the stored image data even if it is leaked from the memory.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language adopted in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be adopted where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be adopted: “e.g.” which means “for example”, and “NB” which means “note well”.

What is claimed is:

1. an image processing apparatus, comprising:
a first reader that reads a first side of a document;
a second reader that reads a second side of the document;
a reducer that reduces in the sub-scanning direction image data read out by said first reader from the first side of the document and image data read out by said second reader from the second side of the document;
a storage that stores therein the respective image data reduced by said reducer, which originate from the first and second sides of the document;
a judger that judges based on the respective image data stored in said storage, which originate from the first and second sides of the document, whether or not the document is a particular document; and
a controller that prohibits said respective image data originating from the first and second sides of the document, from being outputted, depending on a judgment result drew by said judger.

2. An image processing apparatus as recited in claim 1, wherein said storage stores thereon in alternating layers the respective image data reduced by said reducer, which originate from the first and second sides of the document, and said judger makes judgment based on the respective image data stored in alternating layers on said storage.

3. An image processing apparatus as recited in claim 2, wherein said storage stores thereon in alternating layers data of lines from the respective image data reduced by said reducer, which originate from the first and second sides of the document.

4. an image processing method, comprising:
a first reading step to read a first side of a document;
a second reading step to read a second side of the document;
a reducing step to reduce in the sub-scanning direction image data read out from the first side of the document in said first reading step and image data read out from the second side of the document in said second reading step;
a storing step to store in a storage the respective image data reduced in said reducing step, which originate from the first and second sides of the document;
a judging step to judge based on the respective image data stored in said storage, which originate from the first and second sides of the document, whether or not the document is a particular document; and
a prohibiting step to prohibit the respective image data originating from the first and second sides of the document, from being outputted, depending on a judgment result drew in said judging step.

5. An image processing method as recited in claim 4, wherein:
storing in alternating layers the respective image data reduced in said reducing step, which originate from the first and second sides of the document, in said storing step; and
judging based on the respective image data stored in alternating layers, which originate from the first and second sides of the document.

6. An image processing method as recited in claim 5, wherein:
storing in alternating layers data of lines from the respective image data reduced in said reducing step, which originate from the first and second sides of the document, in said storing step.
